(19) United States
(12) Patent Application Publication
(10) Pub. No.: US 2026/0330788 A1
(43) Pub. Date: Oct. 22, 2026

(54) INFORMATION PROCESSING METHOD AND INFORMATION PROCESSING APPARATUS

(71) Applicant: SONY GROUP CORPORATION, Tokyo (JP)

(72) Inventor: Naoyuki KAWABATA, Tokyo (JP)

(21) Appl. No.: 19/113,847

(22) PCT Filed: Sep. 11, 2023
(86) PCT No.: PCT/JP2023/032952

§ 371 Date: Mar. 20, 2025

(30) Foreign Application Priority Data
Sep. 29, 2022 (JP) 2022-155831

(51) Int. Cl. G06T 19/20; G06T 7/00; G06T 7/70; G06T 17/00

(52) U.S. Cl. CPC G06T 19/20; G06T 7/0002; G06T 7/70; G06T 17/00; G06T 2207/20081; G06T 2207/30168; G06T 2207/30201; G06T 2219/2004

(57) ABSTRACT

The present technology relates to an information processing method and an information processing apparatus capable of improving the quality of a learning data set using a three-dimensional model by three-dimensional CG.

An information processing apparatus controls a state of a three-dimensional model of a person in a three-dimensional virtual space and a rendering condition for rendering the three-dimensional model, and generates, on a basis of the state of the three-dimensional model and the rendering condition, input data including a three-dimensional model image that is an image obtained by rendering the three-dimensional model, and learning data including correct data regarding the three-dimensional model. The present technology can be applied to generation processing of a learning data set of a line-of-sight estimation model, for example.

### TECHNICAL FIELD

The present technology relates to an information processing method and an information processing apparatus, and more particularly, to an information processing method and an information processing apparatus used for machine learning.

### BACKGROUND ART

In recent years, with development of deep learning technology, recognition accuracy of a person or an action in an image is dramatically improved, and a technology for estimating non-linguistic information of a person in an image is actively developed. Among them, a line-of-sight estimation technique related to an object of interest or attention of a person has attracted great attention.

In the line-of-sight estimation technique, machine learning is generally performed using a learning data set that is a set of learning data including a pair of input data including an image of a sample of a person and correct data, similarly to other non-verbal information estimation techniques. Here, the correct data includes line-of-sight information indicating a correct answer of a line-of-sight direction of the sample.

In addition, in machine learning, it is important to collect a learning data set. That is, it is important to collect a large amount of high-quality learning data.

Here, there are roughly two types of methods for collecting learning data for line-of-sight estimation.

The first method is a method for collecting learning data using a sample including an actual person. In this method, for example, learning data including a pair of a face image of a person by live-action and a line-of-sight direction is collected (see, for example, Patent Document 1).

The second method is a method for collecting learning data using a sample including a three-dimensional model (hereinafter, referred to as an avatar) of a person by three-dimensional computer graphics (CG). In this method, for example, learning data including a pair of one-eye image obtained by rendering the eye area of one eye of the avatar and line-of-sight information based on the inclination in the one-eye image of an eyeball object of the avatar is collected (see, for example, Non-Patent Document 1).

### CITATION LIST

### Patent Document

Patent Document 1: Japanese Patent Application Laid-Open No. 2021-190041

### Non-Patent Document

Non-Patent Document 1: X. Zhang, 3 others, “Appearance-based gaze estimation in the wild”, Proceedings of the IEEE Conference on Computer Vision and Pattern Recognition (CVPR), 2015, p.4511-4520

### SUMMARY OF THE INVENTION

### Problems to be Solved by the Invention

In the first method, since an error (noise) is included in line-of-sight information included in correct data or it is difficult to collect large-scale and unbiased data, the first method is now going out of fire. Here, the data bias is a bias of the position of the face in the face image, an unnecessary correlation of the position and inclination of the face when the gaze is directed in a specific direction, and the like.

Specifically, for example, in a case where there are many face images in which the position of the face is in the downward direction in the image, or in a case where the line-of-sight direction is in the right direction, such a bias is assumed that there are many face images in which the face is directed in the right direction, or the like.

On the other hand, the second method has an advantage that, for example, an annotation of accurate line-of-sight information can be performed, a large amount of data can be automatically generated, and various eye area images can be generated by changing the unevenness and texture of the face. Therefore, recently, learning of the line-of-sight estimation model is often performed using the learning data set collected by the second method.

From the above circumstances, it is desired to improve the quality of the learning data set using the avatar.

The present technology has been made in view of such a situation, and aims to improve the quality of a learning data set using a three-dimensional model by three-dimensional CG. As a result, the accuracy of machine learning is improved.

Furthermore, the accuracy of processing using a learning model obtained by machine learning is improved.

### Solutions to Problems

In an information processing method according to a first aspect of the present technology, an information processing apparatus controls a state of a three-dimensional model of a person in a three-dimensional virtual space and a rendering condition for rendering the three-dimensional model, and generates, on the basis of the state of the three-dimensional model and the rendering condition, input data including a three-dimensional model image that is an image obtained by rendering the three-dimensional model, and learning data including correct data regarding the three-dimensional model.

An information processing apparatus according to a second aspect of the present technology includes an estimation unit that executes estimation processing regarding a person by using a learning model generated by learning using a learning data set that is a set of learning data generated on the basis of a state of a three-dimensional model of the person in a three-dimensional virtual space and a rendering condition for rendering the three-dimensional model while changing the state of the three-dimensional model and the rendering condition, the learning data including input data including a three-dimensional model image that is an image obtained by rendering the three-dimensional model and correct data regarding the three-dimensional model.

In an information processing method according to the second aspect of the present technology, an information processing apparatus executes estimation processing regarding a person by using a learning model generated by learning using a learning data set that is a set of learning data generated on the basis of a state of a three-dimensional model of the person in a three-dimensional virtual space and a rendering condition for rendering the three-dimensional model while changing the state of the three-dimensional model and the rendering condition, the learning data including input data including a three-dimensional model image that is an image obtained by rendering the three-dimensional model and correct data regarding the three-dimensional model.

In the first aspect of the present technology, a state of a three-dimensional model of a person in a three-dimensional virtual space and a rendering condition for rendering the three-dimensional model is controlled, and on the basis of the state of the three-dimensional model and the rendering condition, input data including a three-dimensional model image that is an image obtained by rendering the three-dimensional model, and learning data including correct data regarding the three-dimensional model is generated.

In the second aspect of the present technology, executing estimation processing regarding a person is executed by using a learning model generated by learning using a learning data set that is a set of learning data generated on the basis of a state of a three-dimensional model of the person in a three-dimensional virtual space and a rendering condition for rendering the three-dimensional model while changing the state of the three-dimensional model and the rendering condition, the learning data including input data including a three-dimensional model image that is an image obtained by rendering the three-dimensional model and correct data regarding the three-dimensional model.

### BRIEF DESCRIPTION OF DRAWINGS

FIG. 1 is a diagram illustrating an example of a one-eye image for learning and a one-eye image for fine tuning.

FIG. 2 is a block diagram illustrating a first embodiment of an information processing system to which the present technology is applied.

FIG. 3 is a block diagram illustrating a configuration example of a learning data set generation unit in FIG. 2.

FIG. 4 is a flowchart for explaining information processing executed by the information processing system in FIG. 2.

FIG. 5 is a flowchart for explaining details of learning data set generation processing.

FIG. 6 is a diagram illustrating an example of an object generated in a CG space.

FIG. 7 is a diagram illustrating an example of a direction in which a direction of a face of an avatar is changed.

FIG. 8 is a diagram illustrating an example of a direction in which the direction of the face of the avatar is changed.

FIG. 9 is a diagram illustrating an example of a direction in which the direction of the face of the avatar is changed.

FIG. 10 is a diagram illustrating an example of a direction in which the direction of the face of the avatar is changed.

FIG. 11 is a diagram illustrating an example of a direction in which the direction of the face of the avatar is changed.

FIG. 12 is a diagram illustrating an example of a movement direction of a camera object.

FIG. 13 is a diagram illustrating an example of a method for changing the position of the face of the avatar.

FIG. 14 is a diagram illustrating an example of a position of a gaze point object.

FIG. 15 is a diagram illustrating an example of the position of the gaze point object.

FIG. 16 is a diagram illustrating an example of a relationship between a position of each object and an avatar image.

FIG. 17 is a diagram illustrating an example of the avatar image.

FIG. 18 is a diagram illustrating an example of the avatar image.

FIG. 19 is a diagram illustrating an example in which the avatar is in a state similar to that of the white of the eye.

FIG. 20 is a block diagram illustrating a second embodiment of an information processing system to which the present technology is applied.

FIG. 21 is a block diagram illustrating a configuration example of a learning data set generation unit in FIG. 20.

FIG. 22 is a flowchart for explaining details of learning data set generation processing executed by the information processing system in FIG. 21.

FIG. 23 is a block diagram illustrating a third embodiment of an information processing system to which the present technology is applied.

FIG. 24 is a block diagram illustrating a configuration example of a learning data set replenishment unit.

FIG. 25 is a flowchart for explaining information processing executed by the information processing system in FIG. 23.

FIG. 26 is a flowchart for explaining details of learning data set generation processing.

FIG. 27 is a block diagram illustrating a configuration example of a computer.

### MODE FOR CARRYING OUT THE INVENTION

Hereinafter, modes for carrying out the present technology will be described. The description will be given in the following order.
1. Background of Present Technology
2. First Embodiment
3. Second Embodiment
4. Third Embodiment
5. Modifications
6. Others

### 1. Background of Present Technology

First, the background of the present technology will be described.

As described in Non-Patent Document 1, in conventional machine learning of a line-of-sight estimation model using an avatar, a learning data set that is a set of learning data including a pair of a one-eye image and line-of-sight information based on the one-eye image is used. In this case, in a case where the line-of-sight direction is estimated on the basis of the captured image obtained by capturing the actual person using the line-of-sight estimation model obtained by machine learning, for example, the following four problems occur.
1. Since the line-of-sight estimation is executed for each eye using one-eye image cut out from the captured image, there is a case where the estimation directions of the lines of sight of the respective eyes do not intersect due to the estimation error. In this case, since the line-of-sight estimation model cannot cope with this, another algorithm is required to estimate the final line-of-sight direction.

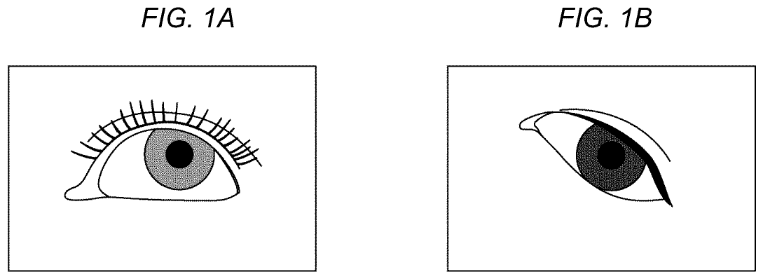

12. In a case where fine tuning of the line-of-sight estimation model is executed using the captured image obtained by capturing the user at the time of operation, there is a case where the one-eye image for fine tuning obtained from the captured image is greatly different from the characteristic of the one-eye image for learning included in the learning data. For example, A of FIG. 1 schematically illustrates an example of a one-eye image for learning, and B of FIG. 1 schematically illustrates an example of a one-eye image for fine tuning. For example, the inclination of the eye, the size of the eye, the number of pixels, and the like may be greatly different between the one-eye image for learning and the one-eye image for fine tuning. Therefore, it may be difficult to process the one-eye image for learning and the one-eye image for fine tuning in the same manner.
3. In the conventional machine learning of the line-of-sight estimation model using the avatar, since the positional relationship between the avatar eye and the camera is substantially constant, the resolution of the rendered one-eye image is also substantially constant. On the other hand, at the time of operation, since the relative position between the camera and the human dynamically changes, the one-eye image is not always obtained with the same resolution. In addition, the appearance of the eyes varies depending on the position of the face in the captured image due to perspective, distortion, or the like of the captured image. Therefore, in a case where the line-of-sight estimation is executed using the one-eye image cut out from the captured image, the estimation accuracy sometimes decreases.
4. In Non-Patent Document 1, the inclination of the face in the roll direction (the direction in which the head is tilted) is not considered. Therefore, in a case where the eye area image is cut out from the captured image in which the face is inclined in the roll direction, a mechanism for separately detecting the inclination of the face is required.

On the other hand, the present technology solves these problems and improves the accuracy of a learning model (hereinafter, referred to as an estimation model) that executes estimation processing regarding a person, such as a line-of-sight estimation model.

### 2. First Embodiment

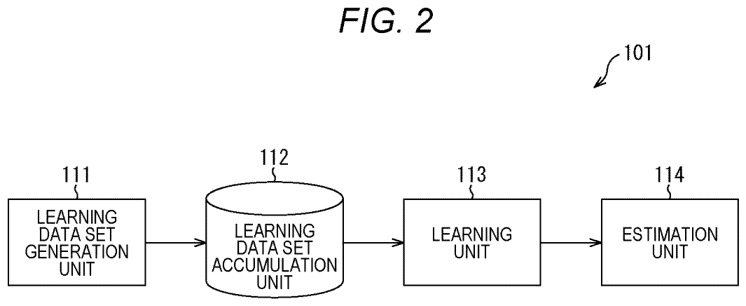

Next, a first embodiment of the present technology will be described with reference to FIGS. 2 to 18.

### <Configuration Example of Information Processing System 101>

First, a configuration example of an information processing system 101 to which the present technology is applied will be described with reference to FIG. 2.

The information processing system 101 is a system that executes machine learning using an avatar that is a three-dimensional model of a person by CG and executes estimation processing regarding the person on the basis of a result of the machine learning.

The information processing system 101 includes a learning data set generation unit 111, a learning data set accumulation unit 112, a learning unit 113, and an estimation unit 114.

The learning data set generation unit 111 generates an avatar in a CG space and generates a learning data set using the avatar. The learning data set generation unit 111 accumulates the generated learning data set in the learning data set accumulation unit 112.

The learning unit 113 performs machine learning using the learning data set accumulated in the learning data set accumulation unit 112 and generates an estimation model for executing estimation processing regarding a person. The learning unit 113 supplies the estimation model to the estimation unit 114.

The estimation unit 114 includes a system, a device, or a program that executes estimation processing regarding a person on the basis of a captured image obtained by capturing an actual person using the estimation model. For example, the estimation unit 114 estimates non-linguistic information (for example, at least one of a state or a characteristic) of a person on the basis of the captured image. Furthermore, the estimation unit 114 further executes various types of processing on the basis of the result of the estimation processing as necessary.

### <Configuration Example of Learning Data Set Generation Unit 111>

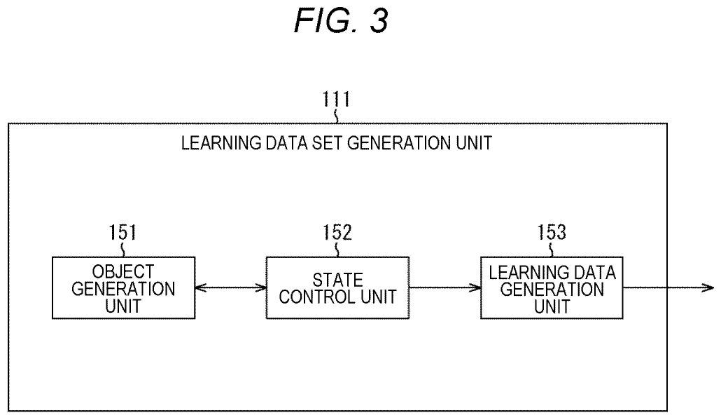

FIG. 3 illustrates a configuration example of the learning data set generation unit 111.

The learning data set generation unit 111 includes an object generation unit 151, a state control unit 152, and a learning data generation unit 153.

The object generation unit 151 generates various objects in the CG space. For example, the object generation unit 151 generates an avatar, a camera object used for controlling a rendering condition of the avatar (virtual imaging of the avatar), a gaze point object indicating a position at which the avatar gazes, and the like in the CG space. The object generation unit 151 supplies the generated information regarding each object to the state control unit 152.

The state control unit 152 controls a condition for generating the learning data by controlling, for example, the state of the CG space and the state of each object in the CG space. The state of the CG space includes, for example, a state regarding a rendering condition (virtual imaging condition) at the time of rendering. Specifically, for example, the state of the CG space includes a light beam or an illumination state of the CG space, a background of the CG space, and the like. The state of each object in the CG space includes, for example, the states of the avatar, the camera object, and the gaze point object described above. The state control unit 152 supplies information regarding the CG space (hereinafter, referred to as CG space information) to the learning data generation unit 153. The CG space information includes, for example, information regarding a state of the CG space and a state of each object in the CG space.

Furthermore, the state control unit 152 instructs the object generation unit 151 to generate an object in the CG space as necessary.

The learning data generation unit 153 generates learning data on the basis of the state of the CG space and the state of each object in the CG space. The learning data includes input data and correct data for the input data.

The input data includes an image (hereinafter, referred to as an avatar image) obtained by rendering the avatar in the CG space (virtually imaging by the camera object).

The correct data includes information indicating a correct answer of at least one of the state or the characteristic of the avatar in the avatar image. For example, in a case of learning an estimation model (line-of-sight estimation model) that estimates a line of sight of a person, the correct data includes line-of-sight information that is information indicating a correct answer of the line-of-sight direction of the avatar.

The learning data generation unit 153 adds the generated learning data to the learning data set accumulated in the learning data set accumulation unit 112.

Note that, an example in which the information processing system 101 learns a line-of-sight estimation model for estimating a line-of-sight direction of a person and estimates the line-of-sight direction of the person using the line-of-sight estimation model will be described below.

### <Information Processing by Information Processing System 101>

Next, information processing executed by the information processing system 101 will be described with reference to the

In step S1, the learning data set generation unit 111 executes learning data set generation processing.

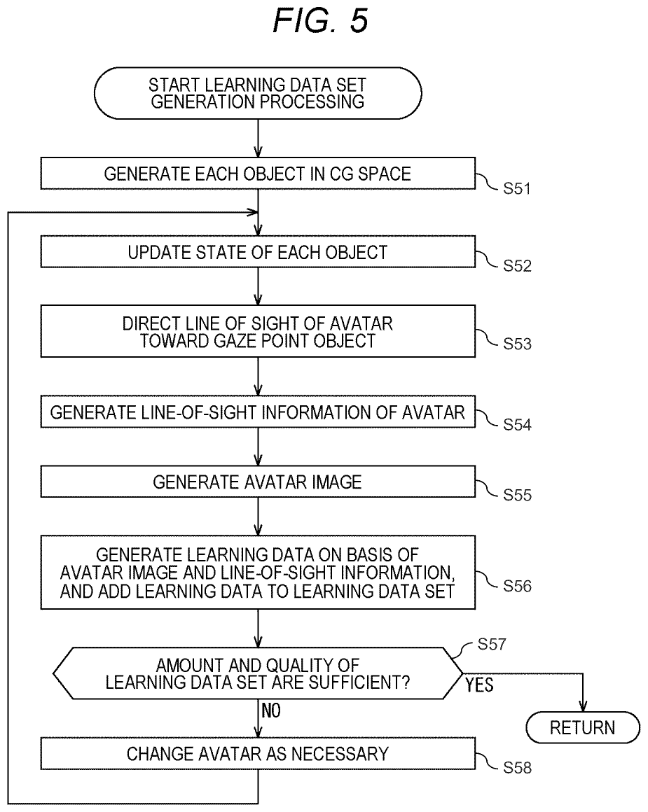

Here, details of the learning data set generation processing will be described with reference to the flowchart of FIG. 5.

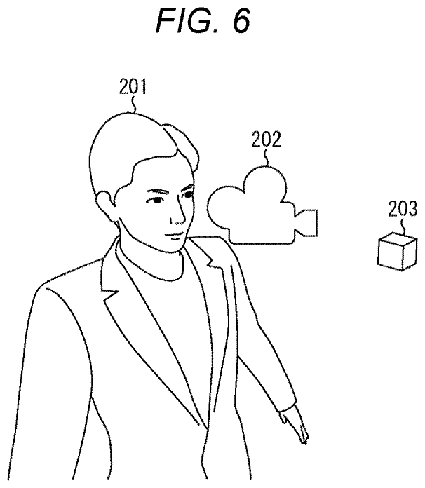

In step S51, the object generation unit 151 generates each object in the CG space. For example, as illustrated in FIG. 6, the object generation unit 151 generates the avatar 201, the camera object 202, and the gaze point object 203 in the CG space.

In the above-described conventional technique, it is possible to generate one-eye image by simply designating the rotation angle of the eyeball of one eye of the avatar. On the other hand, in the present technology, a mechanism for directing the lines of sight of both eyes of the avatar to the same coordinates is required.

On the other hand, the avatar 201 includes an eyeball object in each eye, and can individually control the direction of the eyeball of each eye. Therefore, for example, the avatar 201 can direct the lines of sight of both eyes to the gaze point object 203 (the same coordinates in the CG space).

Note that, hereinafter, the type of the avatar 201 may be different depending on the figure, but the signs are not basically distinguished.

The object generation unit 151 supplies the generated information regarding each object to the state control unit 152.

In step S52, the state control unit 152 updates the state of each object.

In a case where the line-of-sight estimation model is actually operated, conditions for capturing an image of a person as a line-of-sight estimation target change variously. For example, the relative position and posture between the face of the person and the camera, and the direction of the eyeball of the person change variously. As a result, the position, size, and direction of the face of the person and the direction of the eyeball in the captured image change.

On the other hand, for example, the state control unit 152 changes the state of each object in the CG space such that variations in the position, size, and direction of the face of the avatar 201 and the direction of the eyeball in the avatar image are widened for one avatar 201. Specifically, for example, the state control unit 152 changes the relative position and posture of the face of the avatar 201 and the camera object 202, and the position of the gaze point object 203 with respect to the eye of the avatar 201.

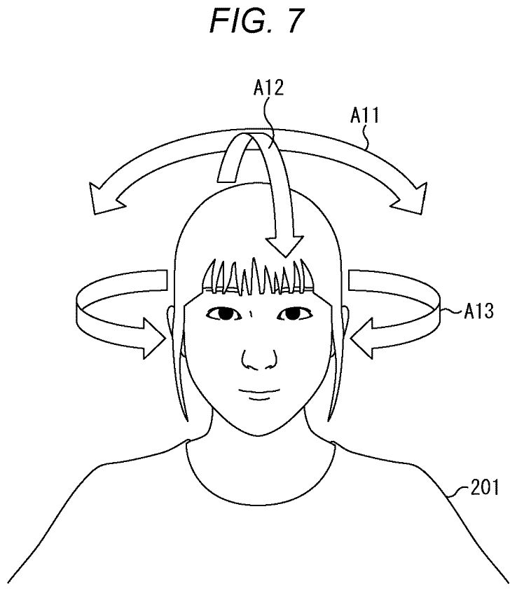

For example, as illustrated in FIG. 7, the state control unit 152 changes the direction of the face of the avatar 201 around three axes of a roll axis, a pitch axis, and a yaw axis. As a result, the direction of the face of the avatar 201 changes in the direction of the arrow A11 (roll direction), the direction of the arrow A12 (pitch direction), and the direction of the arrow A13 (yaw direction).

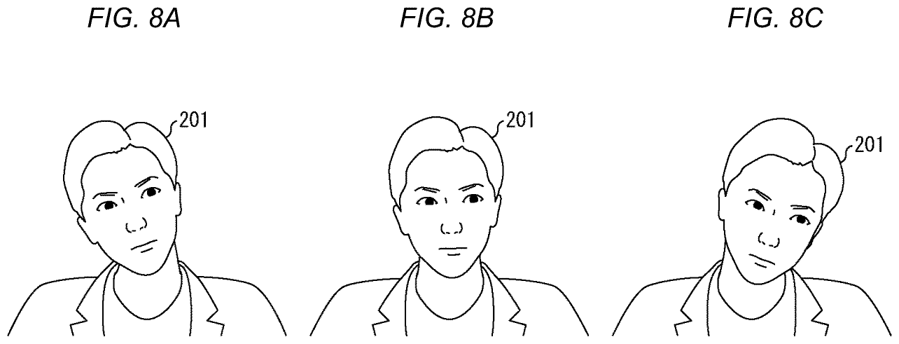

More specifically, for example, as illustrated in FIG. 8, the roll angle of the face of the avatar 201 is changed with a predetermined step size within a predetermined range. Note that, for example, as illustrated in B of FIG. 8, the roll angle is based on a direction in which the face of the avatar 201 faces the front (0°). Then, as illustrated in A of FIG. 8, a direction in which the face of the avatar 201 is inclined rightward is set as a negative direction, and as illustrated in C of FIG. 8, a direction in which the face of the avatar 201 is inclined leftward is set as a positive direction.

For example, in a case where the range in which the roll angle of the face of the avatar 201 is changed is −25° to +25° and the step size is 5°, the roll angle of the face of the avatar 201 changes in 11 steps. As a result, the above-described problem 4 of the prior art is solved.

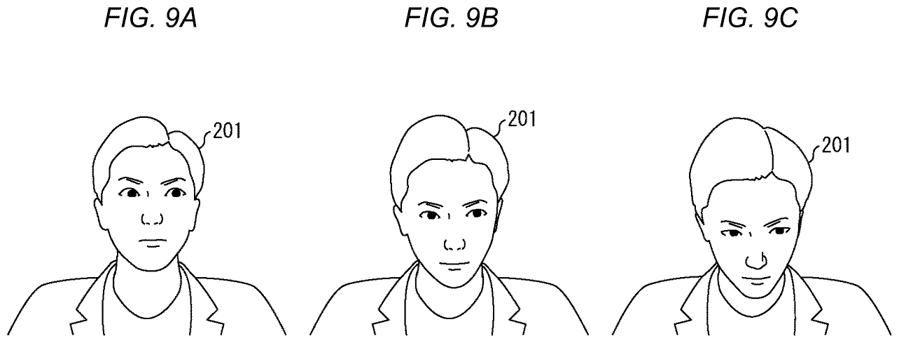

For example, as illustrated in FIG. 9, the pitch angle of the face of the avatar 201 is changed by a predetermined step size within a predetermined range. Note that, for example, as illustrated in B of FIG. 9, the pitch angle is based on a direction in which the face of the avatar 201 faces the front (0°). Then, as illustrated in A of FIG. 9, a direction in which the face of the avatar 201 is inclined upward is set as a negative direction, and as illustrated in C of FIG. 9, a direction in which the face of the avatar 201 is inclined downward is set as a positive direction.

For example, in a case where the range in which the pitch angle of the face of the avatar 201 is changed is −25° to +25°, and the step size is 5°, the pitch angle of the face of the avatar 201 changes in 11 steps.

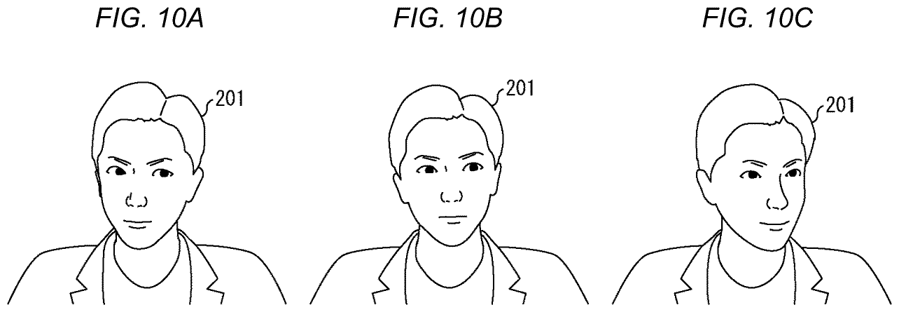

For example, as illustrated in FIG. 10, the yaw angle of the face of the avatar 201 is changed by a predetermined step size within a predetermined range. Note that, for example, as illustrated in B of FIG. 10, the yaw angle is based on a direction in which the face of the avatar 201 faces the front (0°). Then, as illustrated in A of FIG. 10, a direction in which the face of the avatar 201 faces rightward is set as a negative direction, and as illustrated in C of FIG. 10, a direction in which the face of the avatar 201 faces leftward is set as a positive direction.

For example, in a case where the range in which the yaw angle of the face of the avatar 201 is changed is −25° to +25° and the step size is 5°, the yaw angle of the face of the avatar 201 changes in 11 steps.

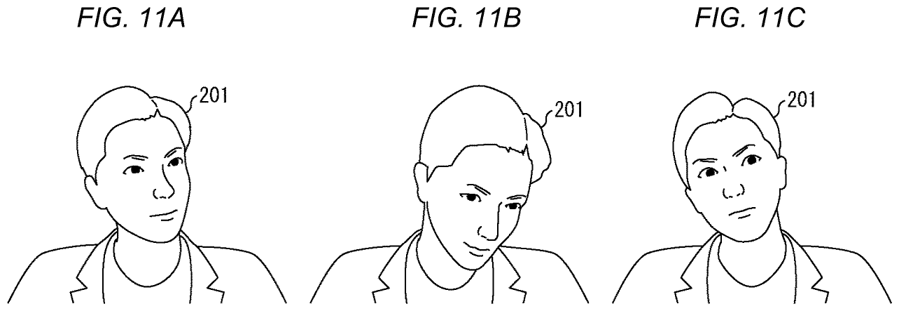

Note that, for example, as illustrated in A to C of FIG. 11, the direction of the face of the avatar 201 may be changed by combining two or more of the roll angle, the pitch angle, and the yaw angle.

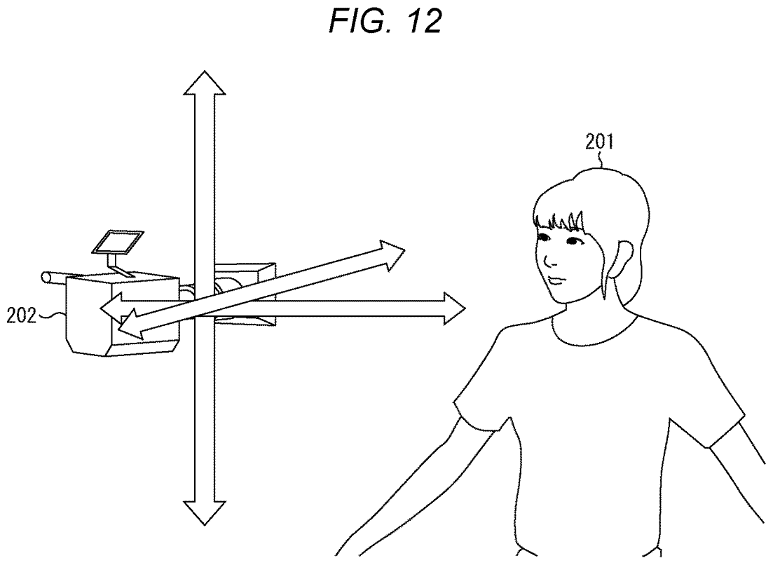

Furthermore, for example, as illustrated in FIG. 12, the state control unit 152 translates the camera object 202 in the left-right direction, the up-down direction, and the front-back direction with respect to the face of the avatar 201. As a result, the relative position between the face of the avatar 201 and the camera object 202 changes. Furthermore, by combining with the change in the direction of the face of the avatar 201, the relative posture between the face of the avatar 201 and the Camera object 202 changes.

Note that, for example, the relative position between the face of the avatar 201 and the camera object 202 may be changed by moving only the avatar 201 or moving both the avatar 201 and the camera object 202.

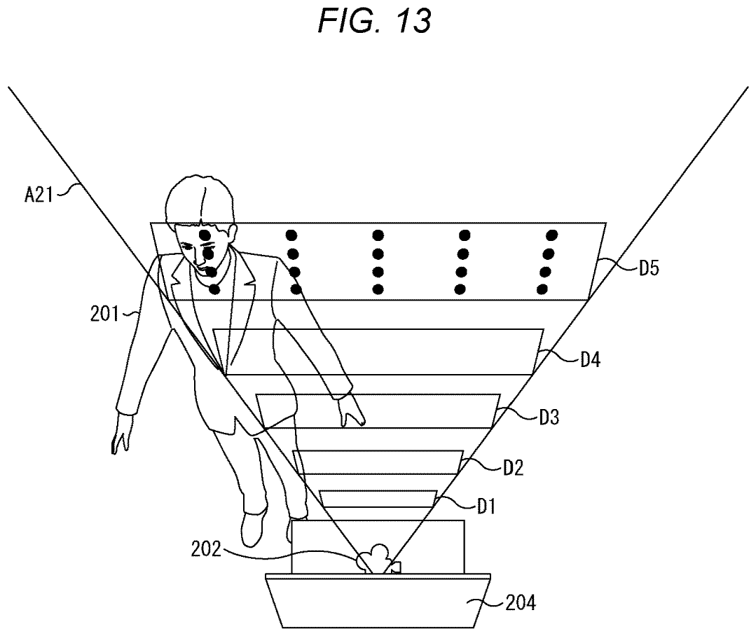

For example, FIG. 13 illustrates an example in a case where a camera mounted on a laptop personal computer (PC) 204 is assumed as the camera object 202.

For example, the state control unit 152 moves the position of the face of the avatar 201 within a virtual imaging range A21 of the camera object 202.

For example, the distance of the avatar 201 with respect to the camera object 202 is changed in five stages of a distance D1 to a distance D5. Furthermore, at each distance, the position of the face of the avatar 201 in the up-down direction (height direction) and the left-right direction (lateral direction) is changed. For example, in the example of FIG. 13, in a case where the distance between the avatar 201 and the camera object 202 is the distance D5, the position of the face of the avatar 201 is set to a total of 20 places of 4 places at predetermined intervals in the up-down direction×5 places at predetermined intervals in the left-right direction in the imaging range A21.

Then, for example, by setting the position of the face of the avatar 201 to 20 positions at each distance, the relative position between the face of the avatar 201 and the camera object 202 changes in 100 ways.

Note that, in the following, an example will be described in which the relative position between the avatar 201 and the camera object 202 is changed by moving the position of the camera object 202.

Furthermore, for example, the relative posture between the face of the avatar 201 and the camera object 202 may be changed by changing only the posture of the camera object 202 or changing the postures of both the avatar 201 and the camera object 202. Furthermore, not only the direction of the face of the avatar 201 but also the direction of the entire body of the avatar 201 may be changed.

Note that, in the following, an example will be described in which the direction of the face of the avatar 201 is changed to change the relative posture between the face of the avatar 201 and the camera object 202.

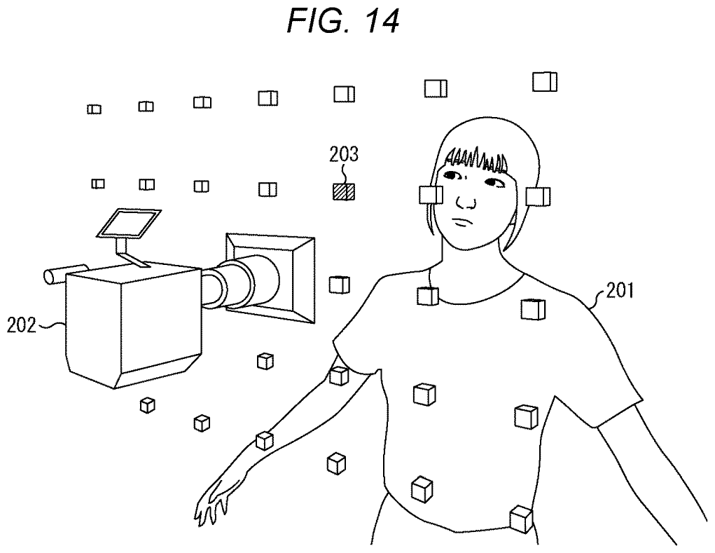

Moreover, for example, as illustrated in FIG. 14, the state control unit 152 moves the gaze point object 203 in the left-right direction and the up-down direction on the camera plane. The camera plane is, for example, a plane perpendicular to the optical axis of the camera object 202 at the front end of the camera object 202. The rectangular parallelepiped frames arranged in a lattice pattern on the camera plane indicate candidates for the position of the gaze point object 203. Among them, a rectangular parallelepiped frame indicated by an oblique line pattern indicates the current position of the gaze point object 203.

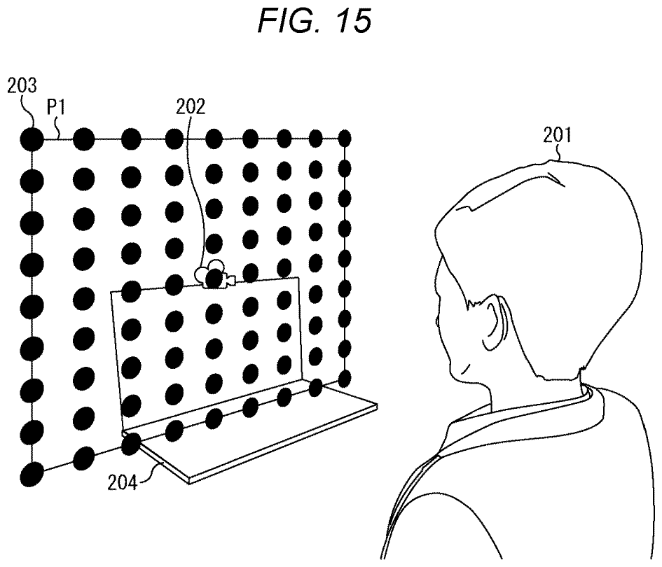

FIG. 15 illustrates another example of candidates for the position of the gaze point object 203. Similarly to the example of FIG. 12, FIG. 15 illustrates an example in a case where the camera mounted on the laptop PC 204 is assumed as the camera object 202.

For example, on a camera plane P1 of the camera object 202, a total of 81 points, that is, 9 points in the left-right direction×9 points in the up-down direction with the optical axis of the camera object 202 as the center, are set as candidates for the position of the gaze point object 203. For example, the interval between the candidate positions is set to 5 cm in both the up-down direction and the left-right direction.

By moving the position of the gaze point object 203 in this manner, the relative position between the face of the avatar 201 and the gaze point object 203 changes.

Note that each gaze point object 203 is not necessarily arranged on the camera plane. Furthermore, the gaze point objects 203 are not necessarily arranged on the same plane.

As described above, the state control unit 152 changes the combination of the states of the objects by, for example, a predetermined algorithm in order to widen the variation of the avatar image. Then, in step S52, the state control unit 152 updates the state of each object to one of the combinations of the states of each object for which the learning data has not been generated yet.

Returning to FIG. 5, in step S53, the state control unit 152 directs the line of sight of the avatar 201 toward the gaze point object 203. For example, the state control unit 152 calculates the relative position between the eyeball object of each eye of the avatar 201 and the gaze point object 203. The state control unit 152 calculates the direction (rotation angle) of the eyeball object of each eye in a case where the line of sight of each eye of the avatar 201 faces the direction of the gaze point object 203 on the basis of the relative position between the eyeball object of each eye of the avatar 201 and the gaze point object 203.

The state control unit 152 rotates the eyeball object of each eye of the avatar 201 on the basis of the calculated rotation angle. For example, the eyeball object is rotated such that a line (pupil center line) connecting the center of the eyeball object of each eye of the avatar 201 and the center point of the iris is directed to the gaze point object 203. In this case, for example, the deviation between the pupil center line and the actual fovea occurring in the actual person may be reflected. Furthermore, for example, in consideration of dynamic movement of the line of sight, saccadic, drift, and the like of the eye may be reflected in the movement of the eyeball object.

As a result, the line of sight of the avatar 201 is directed toward the gaze point object 203. That is, both eyes of the avatar 201 look at the direction of the gaze point object 203.

The state control unit 152 supplies CG space information including information indicating the state of the CG space and the state of each object in the CG space set by the processing of steps S52 and S53 to the learning data generation unit 153.

In step S54, the learning data generation unit 153 generates the line-of-sight information of the avatar 201.

Specifically, the learning data generation unit 153 generates the line-of-sight information of the avatar 201 on the basis of one or more of the relative position and posture between the face of the avatar 201 and the camera object 202 in the CG space, the rotation angle of the eyeball object of each eye of the avatar 201, and the position of the gaze point object.

The line-of-sight information of the avatar 201 includes information regarding a line-of-sight direction of the avatar 201. The line-of-sight direction of the avatar 201 is represented by, for example, the rotation angle of the eyeball object of each eye of the avatar 201 when viewed from the camera object 202. Alternatively, for example, the line-of-sight direction of the avatar is represented by the relative position of the point at which the line of sight of each eye of the avatar 201 intersects with respect to the camera object 202. Alternatively, the line-of-sight direction of the avatar is represented by, for example, the relative position of the gaze point object 203 with respect to the camera object 202.

Alternatively, for example, the line-of-sight direction of the avatar 201 may be represented by coordinates in the avatar image instead of the relative position with respect to the camera object 202.

Note that it is desirable to narrow the line-of-sight direction of the avatar 201 in the line-of-sight information to one value so that the line-of-sight direction of the person can be set to one even in a case where the lines of sight of the respective eyes of the person do not intersect due to an estimation error or the like at the time of operation. In this case, for example, the intersection of the lines of sight of both eyes of the avatar 201, the coordinates of the gaze point object 203, and the like are used in the line-of-sight direction of the avatar 201.

Note that, in a case where the lines of sight of both the eyes of the avatar 201 do not intersect, for example, the learning data generation unit 153 may select a line-of-sight direction closer to the gaze point object 203 or may calculate one line-of-sight direction on the basis of the line-of-sight directions of the both eyes.

This makes it possible to accurately estimate the line-of-sight direction of the person without performing calculation other than the line-of-sight estimation model even if the lines of sight of both eyes of the person do not intersect at the time of operation. That is, the above-described problem 1 of the prior art is solved.

In step S55, the learning data generation unit 153 generates an avatar image. For example, the learning data generation unit 153 renders the image of the avatar 201 captured by the camera object 202 in the CG space on the basis of the relative position and posture of the avatar 201 and the camera object 202. As a result, an avatar image including the face of the avatar 201 is generated.

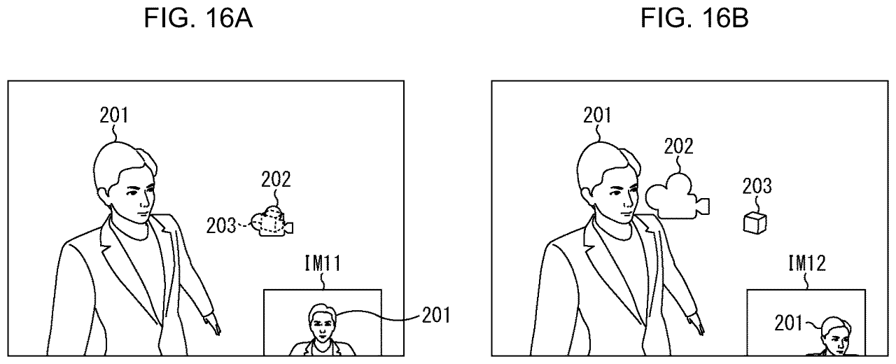

Note that, as illustrated in FIG. 16, even if the positional relationship between the avatar 201 and the gaze point object 203 is the same, in a case where the position of the camera object 202 is different, the generated avatar image changes.

A of FIG. 16 illustrates an example in a case where the positions of the camera object 202 and the gaze point object 203 are substantially the same. In this case, the line of sight of the avatar 201 is directed toward the camera object 202.

Therefore, in an avatar image IM11 generated in this state, for example, the avatar 201 faces the front direction at the substantially center.

B of FIG. 16 illustrates an example in a case where the positions of the camera object 202 and the gaze point object 203 are separated from each other. In this case, the line of sight of the avatar 201 is directed in a direction different from the camera object 202. Therefore, in an avatar image IM12 generated in this state, for example, the avatar 201 faces in the obliquely downward left direction at the lower right corner in the image.

Therefore, even if the avatar 201 and the gaze point object 203 do not move, it is necessary to recalculate the line-of-sight information in a case where at least one of the relative position and posture of the avatar 201 or the camera object 202 changes. This is processing that does not occur in the prior art in which the eyeball is always located at the center of one-eye image.

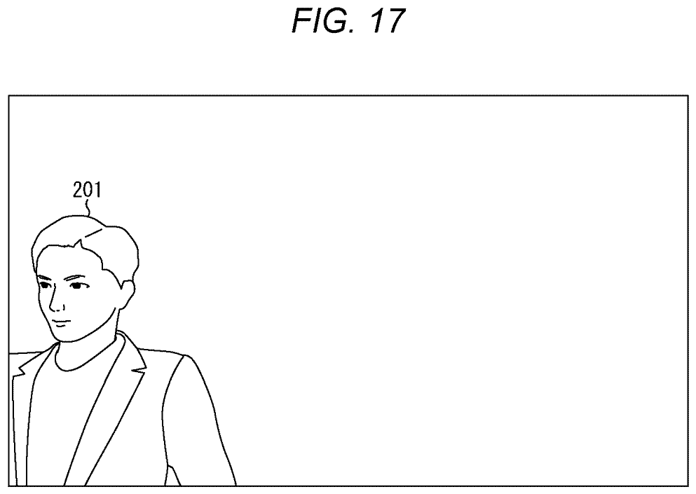

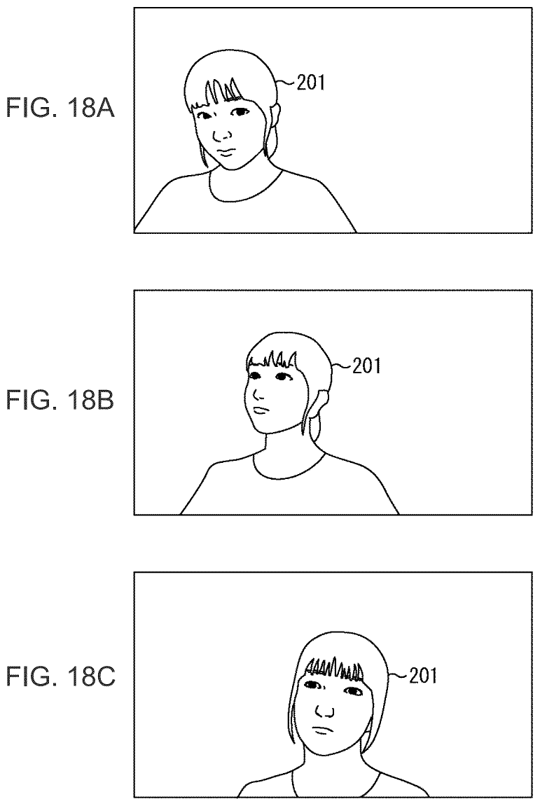

FIGS. 17 and 18 illustrate examples of avatar images.

FIG. 17 illustrates an example of an avatar image in a case where the avatar 201 is not looking in the direction of the camera object 202.

A to C of FIG. 18 illustrate examples of avatar images in a case where the direction of the face of the avatar 201 and the relative position between the face of the avatar 201 and the camera object 202 are different.

A in FIG. 18 illustrates an example of an avatar image in a case where the direction of the line of sight does not coincide with the direction of the face of the avatar 201.

B and C of FIG. 18 illustrate examples of the avatar images in a case where the face and the line of sight of the avatar 201 face in the obliquely upward right direction. However, since the relative position of the camera object 202 with respect to the avatar 201 is different between B and C in FIG. 18, the position and size of the avatar 201 in the avatar image are different.

Returning to FIG. 5, in step S56, the learning data generation unit 153 generates learning data on the basis of the avatar image and the line-of-sight information, and adds the learning data to the learning data set. Specifically, the learning data generation unit 153 generates input data including (the data of) the avatar image generated in the processing of step S55. The learning data generation unit 153 generates correct data including the line-of-sight information of the avatar 201 generated in the processing of step S54. The learning data generation unit 153 generates learning data including input data and correct data. As a result, the avatar image included in the input data and the line-of-sight information included in the correct data are paired. That is, the line-of-sight information indicates the correct answer of the line-of-sight direction of the avatar 201 in the avatar image.

The learning data generation unit 153 adds the generated learning data to the learning data set accumulated in the learning data set accumulation unit 112.

In step S57, the state control unit 152 determines whether or not the amount and the quality of the learning data set are sufficient.

For example, the state control unit 152 determines whether or not the data amount of the learning data set accumulated in the learning data set accumulation unit 112 is sufficient.

Furthermore, for example, the state control unit 152 determines whether or not the variation of the learning data set accumulated in the learning data set accumulation unit 112 is sufficient. For example, the variation of the learning data set is determined on the basis of at least one of the variation of the avatar image included in the input data of each piece of learning data included in the learning data set or the variation of the line-of-sight information included in the correct data.

The variation of the avatar image is determined, for example, on the basis of at least one of the position of the face, the size of the face, the direction of the face, the direction of the eyeballs, or the characteristic of the avatar 201 in the avatar image. As the characteristic of the avatar 201, for example, at least one of race, gender, age, facial makeup, facial size, skin color, or the like of the avatar is assumed.

The variation of the line-of-sight information is determined on the basis of, for example, the variation of the line-of-sight direction indicated by the line-of-sight information.

In a case where the data amount of the learning data set is not yet sufficient, or in a case where the variation of the learning data set is not yet sufficient, the state control unit 152 determines that at least one of the amount and the quality of the learning data set is still insufficient, and the processing proceeds to step S58.

In step S58, the learning data set generation unit 111 changes the avatar 201 as necessary.

For example, in a case where the variation of the learning data generated using the current avatar 201 is sufficient, the state control unit 152 instructs the object generation unit 151 to change the characteristic of the avatar 201 so as to widen the variation of the characteristic of the avatar 201 in the learning data set. For example, the state control unit 152 instructs the object generation unit 151 to change at least one of the race, gender, age, facial makeup, facial size, or skin color of the avatar.

On the other hand, the object generation unit 151 generates a new avatar 201 in the CG space and deletes the old avatar 201 in accordance with the instruction of the state control unit 152. The object generation unit 151 supplies the generated information regarding the avatar 201 to the state control unit 152.

On the other hand, in a case where the variation of the learning data generated using the current avatar 201 is still insufficient, the learning data generation unit 153 determines to continue generation of the learning data while maintaining the current avatar 201.

Thereafter, the processing returns to step S52, and the processing of steps S52 to S58 is repeatedly executed until it is determined in step S57 that the amount and the quality of the learning data set are sufficient.

On the other hand, in step S57, in a case where the data amount of the learning data set is sufficient and the variation of the learning data set is sufficient, the state control unit 152 determines that the amount and the quality of the learning data set are sufficient, and the learning data set generation processing ends.

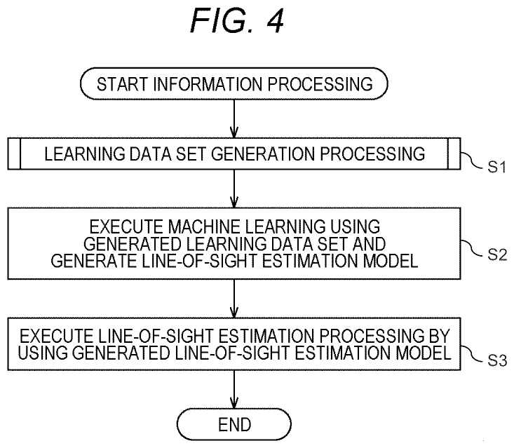

Returning to FIG. 4, in step S2, the learning unit 113 executes machine learning using the generated learning data set and generates a line-of-sight estimation model. Specifically, the learning unit 113 executes machine learning using the learning data set accumulated in the learning data set accumulation unit 112, for example, using a neural network-based learning method. The learning unit 113 supplies the line-of-sight estimation model obtained by the machine learning to the estimation unit 114.

For example, the line-of-sight estimation model is a neural network-based model that estimates the line-of-sight direction of the person in the captured image on the basis of pixel information of the captured image obtained by capturing the target person and feature point information of the face of the person extracted from the input image.

Note that, for example, it is also possible to generate the line-of-sight estimation model by statistically analyzing the position and direction of the face in the avatar image, the movement amount of the iris, and the like, and the line-of-sight information of the correct data.

In step S3, the estimation unit 114 executes line-of-sight estimation processing by using the generated line-of-sight estimation model. For example, the estimation unit 114 estimates a line-of-sight direction of a target person on the basis of a captured image obtained by capturing the person using the line-of-sight estimation model. Specifically, for example, the estimation unit 114 inputs the captured image to the line-of-sight estimation model, and acquires line-of-sight information indicating the line-of-sight direction of the person output from the line-of-sight estimation model.

Note that, for example, the estimation unit 114 may execute various applications using the line-of-sight estimation model.

For example, the estimation unit 114 executes an application that estimates which part of the shared material an auditor is viewing at the time of the online meeting by using the line-of-sight estimation model. As a result, a presenter can add a detailed description regarding contents that the auditor is interested in during presentation, or can supplement and explain contents that the student is likely to overlook.

Thereafter, the information processing ends.

As described above, the quality of the learning data set using the avatar can be improved. Specifically, for example, it is possible to automatically generate a large amount of learning data sets with little bias. As a result, it is possible to improve the learning accuracy of the line-of-sight estimation model while suppressing an increase in the load applied to the generation of the learning data set. In addition, the line-of-sight direction of the person can be estimated with high accuracy using the generated line-of-sight estimation model. That is, the above-described problem 3 of the prior art is solved.

Furthermore, the traceability of the learning data is improved.

For example, the learning data generation unit 153 stores a script at the time of generating each piece of learning data. Each script includes, for example, the type of the avatar 201 at the time of generating the learning data, the state of the CG space, and the state of each object in the CG space. The state of each object in the CG space includes the position and posture of the avatar 201 in the CG space, the position and posture of the camera object 202 in the CG space, the position of the gaze point object 203 in the CG space, and the like.

As a result, the type of the avatar 201 used to generate each piece of learning data, the state of the CG space, and the state of each object in the CG space can be confirmed later.

In addition, even if the learning data is not stored, it is possible to reproduce the learning data by storing the script. As a result, for example, at the time of disclosing the learning data set, consideration of privacy of an individual included in the learning data set becomes unnecessary.

Furthermore, for example, even if the learning data set is not held, in a case where disclosure of the learning data set is requested as long as the avatar 201 has the right, it is possible to easily cope with the request using the script.

### 3. Second Embodiment

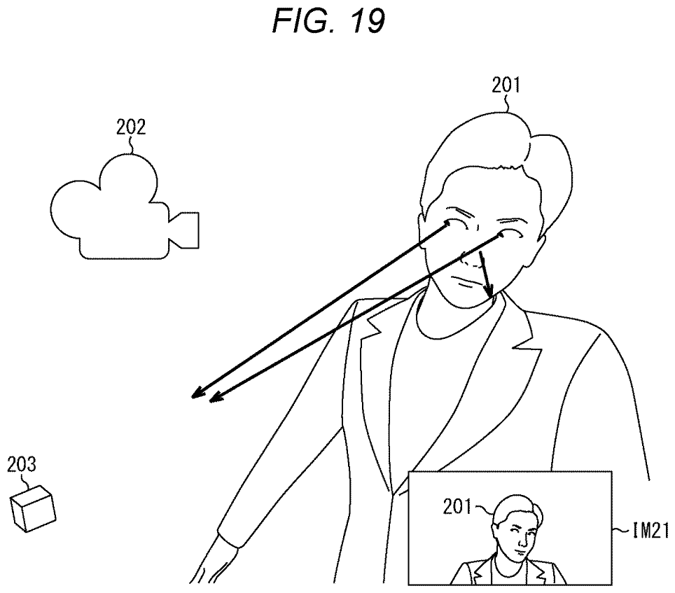

Next, a second embodiment of the present technology will be described with reference to FIGS. 19 to 22.

For example, in a case where the learning data set is generated while changing the state of each object in the CG space as described above, it is assumed that the state of the avatar 201 becomes abnormal depending on the combination of the states of the objects.

Here, the abnormal state of the avatar 201 is, for example, a state in which the avatar image including the avatar 201 in that state becomes an unrealistic image or the like, and in a case where the avatar image is used for machine learning, the learning efficiency may be reduced.

For example, FIG. 19 illustrates an example in which the state of the avatar 201 becomes abnormal.

In this example, the face of the avatar 201 is greatly inclined in the lower left direction. On the other hand, the gaze point object 203 is arranged at a position greatly inclined downward to the right from the face of the avatar 201. Therefore, the lines of sight of both eyes of the avatar 201 are greatly inclined in the lower right direction. Then, since the direction of the line of sight is greatly different from the direction of the face of the avatar 201, the iris portion of the avatar 201 is hardly visible, and both eyes of the avatar 201 are almost white.

As a result, in an avatar image IM21 rendered by the camera object 202, both eyes of the avatar 201 become almost white, and the line-of-sight direction of the avatar 201 becomes unclear.

Therefore, the line-of-sight direction of the avatar 201 of the avatar image IM21 does not match the line-of-sight direction indicated by the line-of-sight information of the correct data, and the learning efficiency may be reduced.

On the other hand, the second embodiment of the present technology improves the quality of the learning data set by excluding the avatar image corresponding to the avatar 201 in the abnormal state, such as the avatar image IM21, from the learning data set.

### <Configuration Example of Information Processing System 301>

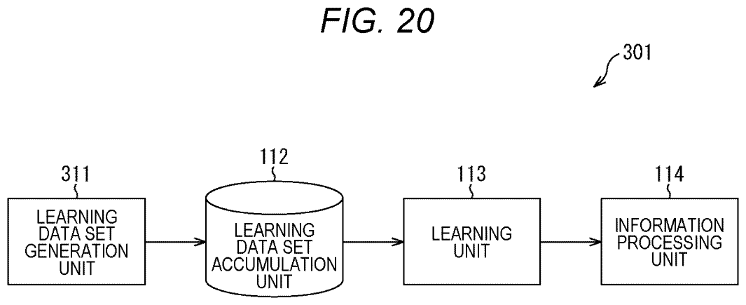

FIG. 20 illustrates a configuration example of an information processing system 301 which is a second embodiment of an information processing system to which the present technology is applied. Note that, in the drawing, portions corresponding to those of the information processing system 101 in FIG. 2 are denoted by the same reference numerals, and the description thereof will be omitted as appropriate.

The information processing system 301 is different from the information processing system 101 in that a learning data set generation unit 311 is provided instead of the learning data set generation unit 111.

### <Configuration Example of Learning Data Set Generation Unit 311>

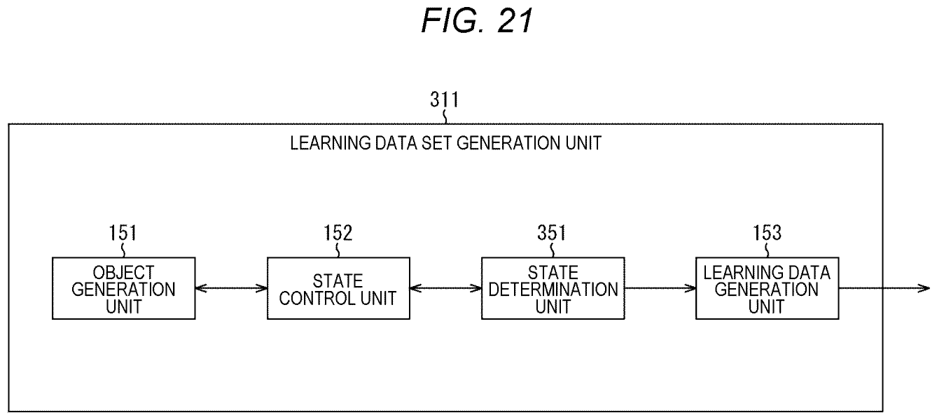

Next, a configuration example of the learning data set generation unit 311 will be described with reference to FIG. 21. Note that, in the drawing, a portion corresponding to that of the learning data set generation unit 111 in FIG. 3 is denoted by the same reference numeral, and the description thereof will be appropriately omitted.

The learning data set generation unit 311 is different from the learning data set generation unit 111 in that a state determination unit 351 is added.

The state determination unit 351 acquires CG space information from the state control unit 152. The state determination unit 351 determines whether or not the state of the avatar 201 is abnormal on the basis of the state of the CG space included in the CG space information and the state of each object in the CG space. In a case where it is determined that the state of the avatar 201 is abnormal, the state determination unit 351 notifies the state control unit 152 that the state of the avatar 201 is abnormal. On the other hand, in a case where it is determined that the state of the avatar 201 is normal, the state determination unit 351 supplies the CG space information acquired from the state control unit 152 to the learning data generation unit 153.

### <Processing in Information Processing System 301>

Next, processing of the information processing system 301 will be described.

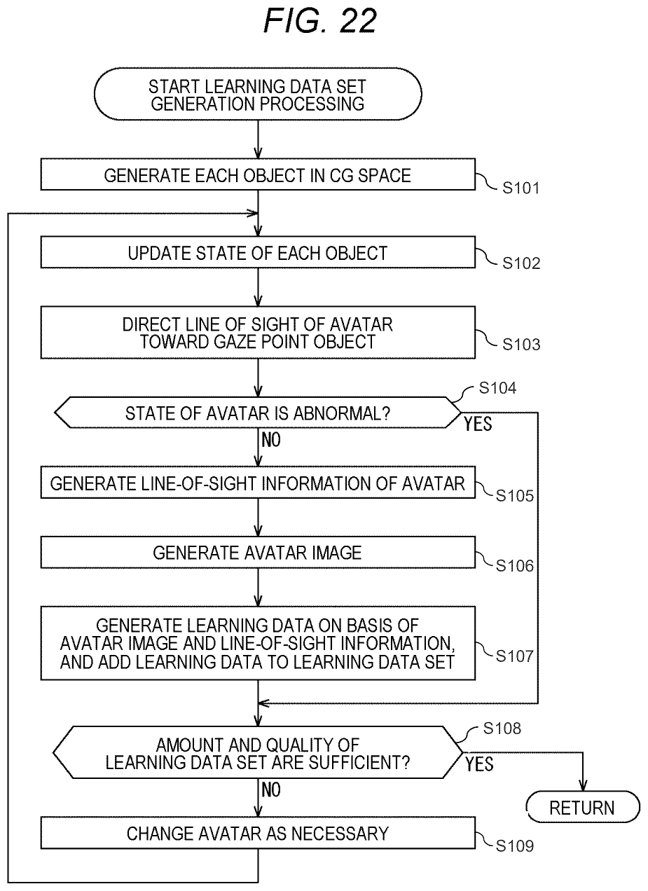

Note that the information processing by the information processing system 301 is executed according to the flowchart of FIG. 4 described above, similarly to the information processing by the information processing system 101. However, the processing is different from the processing of the information processing system 101 in that the learning data set generation processing in step S1 is executed according to the flowchart of FIG. 22.

### <Learning Data Set Generation Processing>

Here, details of the learning data set generation processing of the information processing system 301 will be described with reference to the flowchart of FIG. 22.

In steps S101 and S102, processing similar to that in steps S51 and S52 in FIG. 5 is executed.

In step S103, the state control unit 152 directs the line of sight of the avatar 201 toward the gaze point object 203, similarly to the processing in step S53 in FIG. 5. The state control unit 152 supplies CG space information including information indicating the state of the CG space and the state of each object in the CG space to the state determination unit 351.

In step S104, the state determination unit 351 determines whether or not the state of the avatar 201 is abnormal.

Specifically, the state determination unit 351 determines whether or not the avatar 201 is in an abnormal state on the basis of, for example, one or more of the relative position between the face of the avatar 201 and the camera object 202, the relative posture between the face of the avatar 201 and the camera object 202, and the direction (rotation angle) of the eyeball object of the avatar 201.

For example, as the abnormal state of the avatar 201, a state in which at least one eye of the avatar 201 is invisible in the avatar image is assumed.

As an example of a state in which at least one eye of the avatar 201 is invisible in the avatar image, for example, a state in which at least one eye of the avatar 201 protrudes from the angle of view of the camera object 202 (hereinafter, referred to as an out-of-angle-of-view state) is assumed. That is, at least one eye of the avatar 201 protrudes from the avatar image.

The out-of-angle-of-view state can be detected, for example, on the basis of the relative position between the eyeball object of each eye of the avatar 201 and the camera object 202.

As another example of the state in which at least one eye of the avatar 201 is invisible in the avatar image, for example, a state in which the face of the avatar 201 faces a direction different from the camera object 202 and at least one eye of the avatar 201 is hidden as viewed from the camera object 202 (hereinafter, referred to as a hidden state) is assumed. That is, at least one eye of the avatar 201 is hidden in the avatar image.

The hidden state occurs, for example, in a case where the face of the avatar 201 exists on a line segment connecting the eyeball object of at least one eye of the avatar 201 and the camera object 202. Therefore, the hidden state can be detected on the basis of, for example, the relative position between the eyeball object of each eye of the avatar 201 and the camera object 202 and the relative position between the face of the avatar 201 and the camera object 202.

Furthermore, as the abnormal state of the avatar 201, for example, a state in which at least one eye of the avatar 201 is in a state similar to the white of the eye as viewed from the camera object 202 (hereinafter, referred to as a white-eye state) is assumed. That is, in the avatar image, at least one eye of the avatar 201 is in a state similar to the white of the eye.

Note that the state similar to the white of the eye is, for example, a state in which the ratio or the area of the region of the iris in the eye of the avatar 201 is less than a predetermined threshold value.

The white-eye state occurs, for example, in a case where the difference between the face direction and the line-of-sight direction of the avatar 201 is too large as described above with reference to FIG. 19. Therefore, the white-eye state can be detected on the basis of, for example, the direction of the face of the avatar 201 and the direction (rotation angle) of the eyeball object of each eye.

For example, in a case where none of the out-of-angle-of-view state, the hidden state, and the white-eye state has been detected, the state determination unit 351 determines that the state of the avatar 201 is normal, and supplies the CG space information acquired from the state control unit 152 to the learning data generation unit 153. Thereafter, the processing proceeds to step S105.

In steps S105 to S107, processing similar to that in steps S54 to S56 in FIG. 5 is executed. Then, the processing proceeds to step S108.

On the other hand, in step S104, in a case where at least one of the out-of-angle-of-view state, the hidden state, or the white-eye state is detected, the state determination unit 351 determines that the state of the avatar 201 is abnormal, and notifies the state control unit 152 that the state of the avatar 201 is abnormal. Thereafter, the processing of steps S105 to S107 is skipped, and the processing proceeds to step S108. That is, in a case where the state of the avatar 201 is abnormal, the learning data is not generated, and the learning data based on the avatar 201 determined to be abnormal is not added to the learning data set.

In step S108, it is determined whether or not the amount and the quality of the learning data set are sufficient, similarly to the processing in step S57 of FIG. 7. In a case where it is determined that at least one of the amount and the quality of the learning data set is still insufficient, the processing proceeds to step S109.

In step S109, the avatar 201 is changed as necessary, similarly to the processing in step S58 in FIG. 7.

Thereafter, the processing returns to step S102, and the processing of steps S102 to S109 is repeatedly executed until it is determined in step S108 that the amount and the quality of the learning data set are sufficient. As a result, learning data is generated while changing the state of each object in the CG space and the avatar 201. However, in a case where the state of the avatar 201 is abnormal, the learning data is not generated.

On the other hand, in step S108, in a case where it is determined that the amount and the quality of the learning data set are sufficient, the learning data set generation processing ends.

As described above, the learning data generated in the state where the avatar 201 is abnormal is excluded, and the quality of the learning data set is improved. As a result, the accuracy of the line-of-sight estimation model is improved.

### 4. Third Embodiment

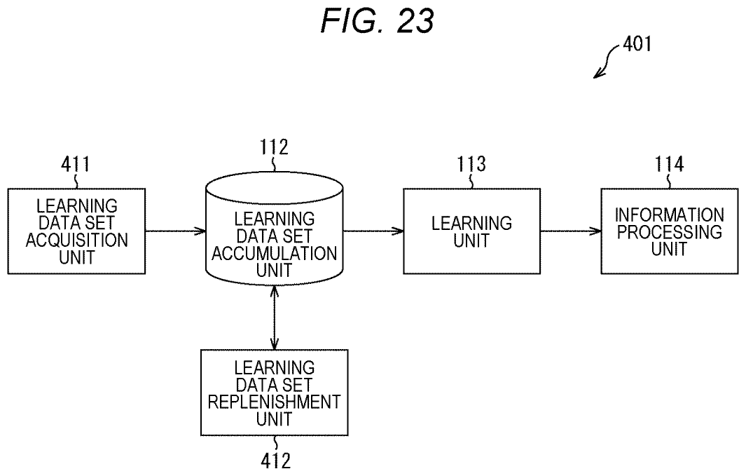

Next, a third embodiment of the present technology will be described with reference to FIGS. 23 to 26.

In a case where a learning data set is generated and used using a captured image obtained by actually capturing a person as in Patent Literature 1 described above, a bias of the learning data set sometimes occurs. Although details of the bias of the learning data set will be described later, for example, a bias such as the position of the face or the line-of-sight direction of the person in the captured image is assumed.

A line-of-sight estimation model learned using a biased learning data set tends to be a non-robust model for a biased element. For example, there is a case where an event occurs in which it is estimated that the line-of-sight direction is the right direction only when the position of the face of the person is on the right in the captured image.

On the other hand, in the third embodiment of the present technology, by using the avatar 201 to replenish the shortage of the acquired learning data set, the bias or the like of the learning data set is reduced, and the amount and the quality of the learning data set are improved.

<Configuration Example of Information Processing System 401>FIG. 23 illustrates a configuration example of an information processing system 401 which is the third embodiment of the information processing system to which the present technology is applied. Note that, in the drawing, portions corresponding to those of the information processing system 101 in FIG. 2 are denoted by the same reference numerals, and the description thereof will be omitted as appropriate.

The information processing system 401 is different from the information processing system 101 in that a learning data set acquisition unit 411 and a learning data set replenishment unit 412 are added and the learning data set generation unit 111 is deleted.

The learning data set acquisition unit 411 acquires a learning data set and accumulates the acquired learning data set in the learning data set accumulation unit 112.

The learning data set replenishment unit 412 replenishes the shortage of the acquired learning data set accumulated in the learning data set accumulation unit 112.

### <Configuration Example of Learning Data Set Replenishment Unit 412>

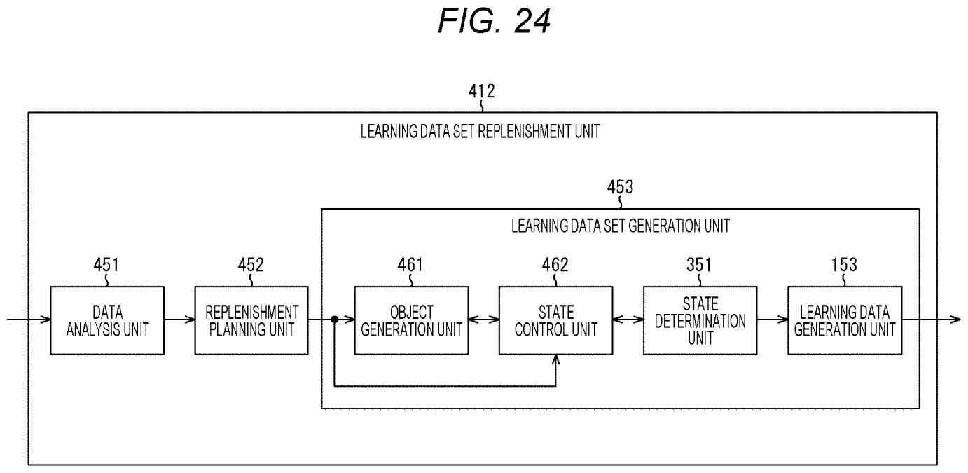

FIG. 24 illustrates a configuration example of the learning data set replenishment unit 412. Note that, in the drawing, a portion corresponding to that of the learning data set generation unit 311 in FIG. 21 is denoted by the same reference numeral, and the description thereof is appropriately omitted.

The learning data set replenishment unit 412 includes a data analysis unit 451, a replenishment planning unit 452, and a learning data set generation unit 453. The learning data set generation unit 453 is different from the learning data set generation unit 311 in that an object generation unit 461 and a state control unit 462 are provided instead of the object generation unit 151 and the state control unit 152.

The data analysis unit 451 analyzes the acquired learning data set accumulated in the learning data set accumulation unit 112. The data analysis unit 451 supplies information indicating an analysis result of the learning data set to the replenishment planning unit 452.

The replenishment planning unit 452 creates a plan for replenishing the shortage of the learning data set on the basis of the analysis result of the learning data set. The replenishment planning unit 452 supplies information indicating a replenishment plan of the learning data set to the object generation unit 461 and the state control unit 462.

The object generation unit 461 generates various objects in the CG space on the basis of the replenishment plan of the learning data set. For example, the object generation unit 461 generates the avatar 201, the camera object 202, the gaze point object 203, and the like in the CG space. The object generation unit 461 supplies the generated information regarding each object to the state control unit 462.

The state control unit 462 controls a condition for generating the learning data by controlling the state of the CG space and the state of each object in the CG space on the basis of the replenishment plan of the learning data set. The state control unit 462 supplies the state determination unit 351 with CG space information including information indicating the state of each object in the CG space and the state of the CG space.

Furthermore, the state control unit 462 instructs the object generation unit 461 to generate an object in the CG space as necessary.

### <Information Processing by Information Processing System 401>

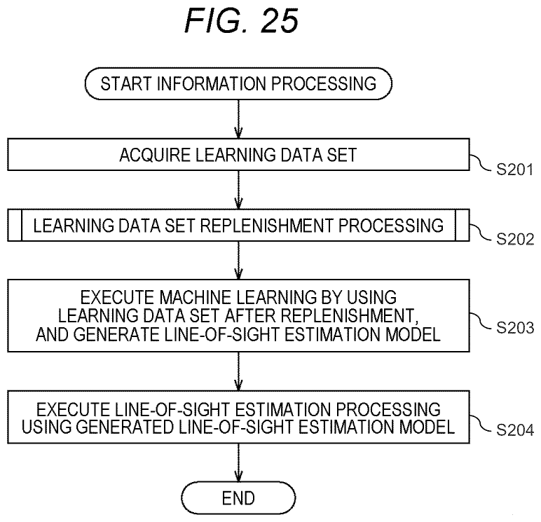

Next, information processing executed by the information processing system 401 will be described with reference to the flowchart of FIG. 25.

In step S201, the learning data set acquisition unit 411 acquires a learning data set.

Note that a method for acquiring the learning data set is not particularly limited. For example, the learning data set acquisition unit 411 automatically collects a learning data set disclosed on the Internet or the like. For example, the learning data set acquisition unit 411 acquires a learning data set input by the user.

Furthermore, the image of the sample of the person (hereinafter, referred to as a sample image) used for the input data of the learning data set may be an image obtained by actually capturing the person (captured image) or an image generated by CG (avatar image).

Furthermore, for example, the learning data set acquisition unit 411 may collect sample images disclosed on the Internet or the like, and generate the learning data set using each sample image and correct data given to the collected sample image.

The learning data set acquisition unit 411 accumulates the acquired learning data set in the learning data set accumulation unit 112.

In step S202, the learning data set replenishment unit 412 executes learning data set replenishment processing.

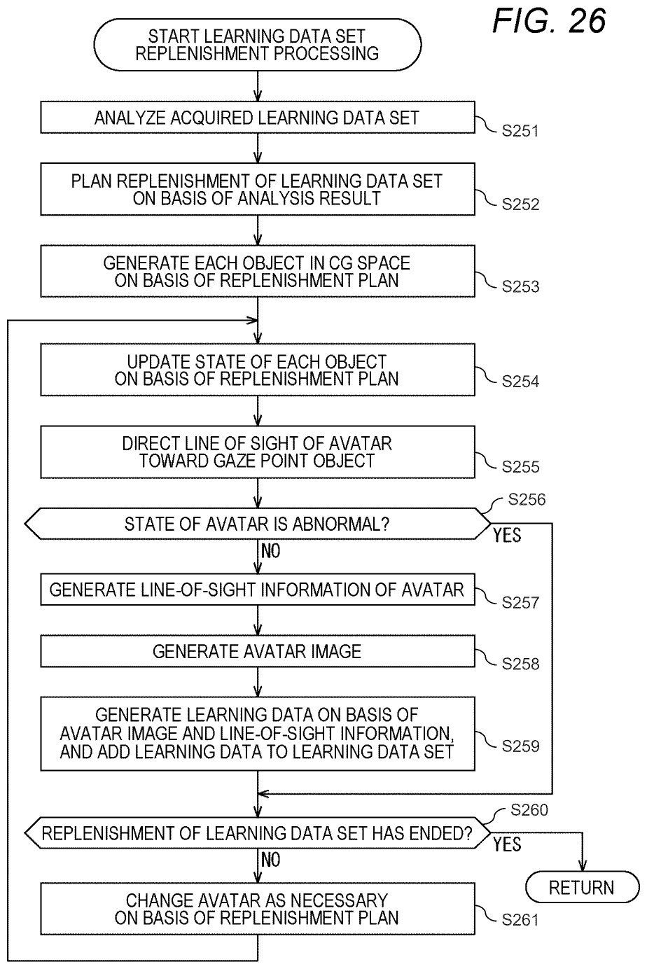

Here, details of the learning data set replenishment processing will be described with reference to the flowchart of FIG. 26.

In step S251, the data analysis unit 451 analyzes the acquired learning data set. That is, the data analysis unit 451 analyzes the learning data set acquired in the processing of step S201 and accumulated in the learning data set accumulation unit 112.

The data analysis unit 451 detects the shortage of the learning data on the basis of the analysis result of the learning data set.

Here, the shortage of the learning data set is, for example, a shortage of at least one of the amount or the quality of the learning data set. The shortage of the amount of the learning data set is, for example, a shortage of the data amount of the learning data set. The shortage of the amount of the learning data set includes, for example, an insufficient variation of the learning data set.

The insufficient variation of the learning data set is represented by, for example, a bias of the learning data set.

The bias of the learning data set includes, for example, a bias of input data and a bias of correct data.

The bias of the input data includes, for example, the bias of the sample and the bias of the sample image. The bias of the sample includes, for example, a characteristic bias of the sample. The bias of the characteristic of the sample includes, for example, at least one bias among race, sex, age, facial makeup, facial size, facial color, or the like. The bias of the sample image includes, for example, a bias of information obtained from the face in the sample image. The bias of the information obtained from the face in the sample image includes, for example, at least one bias among the position of the face, the size of the face, the face orientation, the eyeball orientation, the correlation between the line-of-sight direction and the face orientation, or the like.

The bias of the correct data includes, for example, the bias of the line-of-sight information. The bias of the line-of-sight information includes, for example, a bias of the line-of-sight direction indicated by the line-of-sight information.

The data analysis unit 451 supplies information indicating the detection result of the shortage of the learning data to the replenishment planning unit 452.

In step S252, the replenishment planning unit 452 plans replenishment of the learning data on the basis of the analysis result.

Specifically, for example, the replenishment planning unit 452 plans replenishment of the learning data set so that the learning data set has a sufficient data amount and the bias of the learning data set is corrected. For example, the replenishment planning unit 452 plans the characteristic of the avatar 201 when generating the learning data for replenishment and the state of each object in the CG space.

The characteristic of the avatar includes, for example, at least one of race, gender, age, facial makeup, facial size, facial color, or the like.

The state of each object in the CG space includes, for example, the relative position and posture of the face of the avatar 201 and the camera object 202, the relative position of the gaze point object 203 with respect to the eye of the avatar 201, and the like.

For example, in a case where the distance between the face of the sample and the camera is substantially constant in the sample image of the acquired learning data set, the state of each object in the CG space is planned such that avatar images having different distances between the face of the avatar 201 and the camera object 202 are generated. For example, in a case where the distance between the face of the sample in the sample image and the camera is mainly about 50 cm, the state of each object in the CG space is planned so that the avatar image is generated in a state where the distance between the face of the avatar 201 and the camera object 202 is 40 cm, 60 cm, or 70 cm.

For example, in the acquired learning data set, in a case where there are most sample images in which the sample looks down the camera, the state of each object in the CG space is planned such that an avatar image in which the avatar 201 looks up the camera object 202 is generated. For example, the state of each object in the CG space is planned so that the avatar image is generated in a state where the gaze point object is arranged at positions of 5 cm, 10 cm, and 15 cm above the camera object 202.

For example, in a case where the acquired learning data set includes only sample images of a specific race, generation of the avatar 201 is planned so that the race type of the avatar 201 increases. For example, generation of the avatar 201 is planned so that the proportion of race of the avatar 201 is constant.

The replenishment planning unit 452 generates a replenishment parameter list in which the characteristic of the avatar 201 at the time of generating the learning data for replenishment and the state of each object in the CG space are parameterized on the basis of the replenishment plan of the learning data set. The replenishment planning unit 452 supplies the replenishment parameter list to the object generation unit 461 and the state control unit 462.

In step S253, the object generation unit 461 generates each object in the CG space on the basis of the replenishment plan. For example, the object generation unit 461 sets the characteristic of the avatar 201 on the basis of the replenishment parameter list, and generates the avatar 201 having the set characteristic in the CG space. The object generation unit 461 generates the camera object 202 and the gaze point object 203 in the CG space. The object generation unit 461 supplies the generated information regarding each object to the state control unit 462.

In step S254, the state control unit 462 updates the state in the CG space on the basis of the replenishment plan.

Specifically, the state control unit 462 updates the state of each object to one of the combinations of the states of each object for which the learning data has not been generated yet, on the basis of the replenishment parameter list, similarly to the processing in step S52 in FIG. 5.

In steps S255 to S259, processing similar to that in steps S103 to S107 in FIG. 22 is executed.

At this time, for example, the avatar image is generated in a format similar to the sample image included in the acquired learning data set. As a result, at the time of learning, the learning data included in the acquired learning data set and the replenished learning data can be similarly processed without being distinguished from each other. As a result, the above-described problem 2 of the prior art is solved.

In step S260, the state control unit 462 determines whether or not the replenishment of the learning data set has ended. In a case where a parameter for which learning data has not been generated yet remains in the replenishment parameter list, the state control unit 462 determines that the replenishment of the learning data set has not been ended, and the processing proceeds to step S261.

In step S261, the learning data set generation unit 453 changes the avatar 201 as necessary on the basis of the replenishment plan.

For example, the state control unit 462 determines whether or not the learning data of all the parameters has been generated using the current avatar 201 on the basis of the replenishment parameter list. In a case where it is determined that the learning data of all the parameters has been generated using the current avatar 201, the state control unit 462 selects one of the characteristic of the avatar 201 for which the learning data has not been generated yet on the basis of the replenishment parameter list. The state control unit 462 instructs the object generation unit 461 to change the characteristic of the avatar 201 to the selected characteristic.

On the other hand, the object generation unit 461 generates a new avatar 201 in the CG space and deletes the old avatar 201 in accordance with the instruction of the state control unit 462. The object generation unit 461 supplies information regarding the generated avatar 201 to the state control unit 462.

On the other hand, in a case where it is determined that the learning data of all the parameters has not been generated yet using the current avatar 201, the state control unit 462 determines to continue generation of the learning data while maintaining the current avatar 201.

Thereafter, the processing returns to step S254, and the processing of steps S254 to S261 is repeatedly executed until it is determined in step S260 that the replenishment of the learning data set has ended.

On the other hand, in step S260, in a case where no parameter for which the learning data is not generated remains in the replenishment parameter list, the state control unit 462 determines that the replenishment of the learning data set has ended, and the learning data set replenishment processing ends.

Returning to FIG. 25, in step S203, the learning unit 113 executes machine learning by using the learning data set after replenishment, and generates a line-of-sight estimation model.

Specifically, the learning unit 113 executes machine learning using a predetermined learning method using the learning data set after replenishment accumulated in the learning data set accumulation unit 112. The learning unit 113 supplies the line-of-sight estimation model obtained by the machine learning to the estimation unit 114.

In step S204, similarly to the processing in step S3 in FIG. 4, the line-of-sight estimation processing is executed using the generated line-of-sight estimation model.

As described above, by replenishing the acquired learning data set, the amount and the quality of the learning data set are improved. The accuracy of the line-of-sight estimation model is improved by performing the machine learning using the learning data set after the replenishment.

Furthermore, the third embodiment of the present technology can be applied to a case of executing fine tuning of the line-of-sight estimation model for a specific user (hereinafter, referred to as a target user.) and optimizing the line-of-sight estimation model for the target user.

For example, in a case where fine tuning of the line-of-sight estimation model is executed for the target user, additional learning is performed using the learning data set acquired using the captured image obtained by capturing the target user.

In this case, for example, in a case where the amount of the learning data set acquired using the captured image is not sufficient or the bias of the learning data set is large, the robustness of the line-of-sight estimation model decreases by optimizing the line-of-sight estimation model with respect to the learning data set.

On the other hand, for example, as described above, the acquired learning data set is replenished using the avatar 201 similar to the target user, so that the amount and the quality of the learning data set for the target user are improved. In addition, the data amount of the learning data set acquired using the captured image obtained by capturing the target user in advance can be reduced, and the load necessary for generating the learning data set is reduced.

Note that whether or not the avatar 201 is similar to the target user can be determined, for example, by comparing feature amounts regarding facial makeup. For example, the avatar 201 having the closest ratio between the distance between the inner corners of the eyes of the target user and the length of the entire face is used as the avatar 201 similar to the target user.

Then, by executing the additional learning using the replenished learning data set, the accuracy of fine tuning is improved, and the estimation accuracy of the line of sight of the target user by the line-of-sight estimation model is improved. For example, robustness of the line-of-sight estimation model is improved.

### 5. Modifications

Hereinafter, modifications of the above-described embodiments of the present technology will be described.

For example, two or more avatars 201 may be generated in the CG space at a time.

For example, in a case where at least one eye of the avatar 201 is in a state similar to the white of the eye, the rotation angle of the eyeball object of the eye may be corrected within a range that does not become the white of the eye.

In the above description, an example has been described in which the learning data is generated while changing the relative position and posture between the face of the avatar 201 and the camera object 202 and the relative position between the face of the avatar 201 and the gaze point object 203. However, the learning data may be generated while changing another state of each object. As such a state of each object, for example, a relative position and posture between the entire body or a portion other than the face of the avatar 201 and the camera object 202, and a relative position between the entire body or the portion other than the face of the avatar 201 and the gaze point object 203 are assumed. Furthermore, for example, an expression, a gesture, or the like of the avatar 201 is assumed.

For example, the learning data may be generated while changing the state of the CG space. As such a state of the CG space, for example, a light beam or an illumination state of the CG space, a background of the CG space, and the like are assumed.

The gaze point object 203 only needs to be able to designate coordinates for controlling the direction (rotation angle) of the eyeball object of the avatar 201, and the appearance is not limited to the above-described example. Furthermore, the gaze point object 203 is not necessarily visible.

In addition to or instead of the abnormality determination of the state of the avatar 201, an abnormality determination for detecting an avatar image that leads to a decrease in the quality of the learning data set may be executed.

The present technology can also be applied to, for example, a case of generating a learning data set of an estimation model for executing estimation processing regarding non-linguistic information (for example, at least one of a state or a characteristic of a person.) of a person other than a line of sight. For example, the present technology can be applied to a case of generating a learning data set of an estimation model for estimating a gesture or an emotion of a person. For example, the present technology can be applied to a case of generating a learning data set of an estimation model that executes lip reading for estimating a speech content of a person by movement of the lips of the person. For example, the present technology can be applied to a case of generating a learning data set of an estimation model for estimating characteristics such as race, gender, and age of a person.

### 6. Others

### <Configuration Example of Computer>

The above-described series of processing can be executed by hardware or software. In a case where the series of processing is executed by software, a program that configures the software is installed in a computer. Here, examples of the computer include a computer incorporated in dedicated hardware, a general-purpose personal computer that can execute various functions by being installed with various programs, and the like.

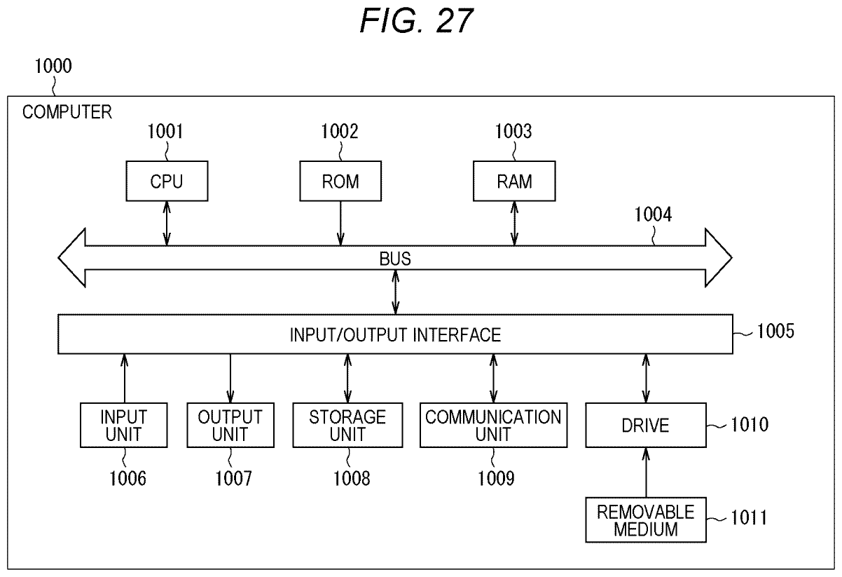

FIG. 27 is a block diagram illustrating a configuration example of hardware of a computer that performs the above-described series of processing by a program.

In a computer 1000, a central processing unit (CPU) 1001, a read only memory (ROM) 1002, and a random access memory (RAM) 1003 are interconnected via a bus 1004.

An input/output interface 1005 is further connected to the bus 1004. An input unit 1006, an output unit 1007, a storage unit 1008, a communication unit 1009, and a drive 1010 are connected to the input/output interface 1005.

The input unit 1006 includes an input switch, a button, a microphone, an imaging element, and the like. The output unit 1007 is formed with a display, a speaker, and the like. The storage unit 1008 is formed with a hard disk, a non-volatile memory, and the like. The communication unit 1009 is formed with a network interface and the like. The drive 1010 drives a removable medium 1011 such as a magnetic disk, an optical disk, a magneto-optical disk, or a semiconductor memory.

In the computer 1000 configured as described above, the series of processing described above is executed, for example, by the CPU 1001 loading a program stored in the storage unit 1008 into the RAM 1003 via the input/output interface 1005 and the bus 1004, and executing.

The program executed by the computer 1000 (CPU 1001) can be provided by being recorded in the removable medium 1011 as a package medium or the like, for example. Furthermore, the program can be provided via a wired or wireless transmission medium such as a local area network, the Internet, or digital satellite broadcasting.

In the computer 1000, the program can be installed in the storage unit 1008 via the input/output interface 1005 by mounting the removable medium 1011 on the drive 1010. Also, the program may be received by the communication unit 1009 by means of the wired or wireless transmission medium to be installed on the storage unit 1008. Further, the program can be installed in the ROM 1002 or the storage unit 1008 in advance.

Note that the program executed by the computer may be a program that performs the pieces of processing in the time-series order described in the present specification, or may be a program that performs the processes in parallel or at necessary timing such as when a call is made.

Furthermore, in the present specification, a system means an assembly of a plurality of components (devices, modules (parts), and the like), and it does not matter whether or not all the components are in the same casing. Therefore, a plurality of devices housed in separate casings and connected to each other via a network and a single device including a plurality of modules housed in a single casing are both systems.

Moreover, the embodiments of the present technology are not limited to the above-described embodiments, and a variety of modifications can be made without departing from the gist of the present technology.

For example, the present technology may be embodied in cloud computing in which a function is executed by a plurality of devices via a network in a shared manner.

Furthermore, each step described in the flowchart described above can be executed by one device or can be performed by a plurality of devices in a shared manner.

Moreover, in a case where a plurality of processes is included in one step, the plurality of pieces of processing included in the one step can be executed by one device or performed by a plurality of devices in a shared manner.

### <Combination Example of Configuration>

The present technology can also have the following configurations.
(1)

An information processing method including, by an information processing apparatus:
controlling a state of a three-dimensional model of a person in a three-dimensional virtual space and a rendering condition for rendering the three-dimensional model; and generating, on the basis of the state of the three-dimensional model and the rendering condition, input data including a three-dimensional model image that is an image obtained by rendering the three-dimensional model, and learning data including correct data regarding the three-dimensional model.
(2)

The information processing method according to (1),
in which the state of the three-dimensional model includes at least one of a position or a posture of the three-dimensional model in the virtual space.
(3)

The information processing method according to (2),
in which the state of the three-dimensional model further includes a direction of an eyeball of the three-dimensional model in the virtual space.
(4)

The information processing method according to (3),
in which the correct data includes line-of-sight information indicating a line-of-sight direction of the three-dimensional model.
(5)

The information processing method according to (4),
in which the three-dimensional model image includes both eyes of the three-dimensional model, and
the line-of-sight information indicates one line-of-sight direction with respect to both the eyes of the three-dimensional model.
(6)

The information processing method according to any one of (3) to (5),
in which the information processing apparatus further controls a position of a gaze point indicating a position at which the three-dimensional model gazes in the virtual space, and
controls a direction of an eyeball of the three-dimensional model on the basis of a relative position between the eyeball of the three-dimensional model and the gaze point.
(7)

The information processing method according to any one of (2) to (6),
in which the information processing apparatus controls a relative position and posture between the three-dimensional model and a camera object used for controlling the rendering condition.
(8)

The information processing method according to any one of (2) to (7), in which a posture of the three-dimensional model includes a direction of a face of the three-dimensional model in the virtual space.
(9)

The information processing method according to any one of (1) to (8),
in which the information processing apparatus controls the state of the three-dimensional model and the rendering condition, and widens a variation of at least one of the state of the three-dimensional model in the three-dimensional model image or the correct data in a learning data set that is a set of the learning data.
(10)

The information processing method according to (9),
in which the learning data set is used for learning of a learning model for estimating at least one of a state or a characteristic of a person.
(11)

The information processing method according to any one of (1) to (10),
in which the information processing apparatus determines the state of the three-dimensional model, and
in a case where the information processing apparatus determines that the state of the three-dimensional model is abnormal, the information processing apparatus does not add the learning data based on the three-dimensional model determined to be abnormal to a learning data set that is a set of the learning data.
(12)

The information processing method according to (11),
in which the state in which the three-dimensional model is abnormal is a state in which learning efficiency may decrease in a case where the learning data including the three-dimensional model image based on the three-dimensional model is used for learning.
(13)

The information processing method according to (12),
in which the state in which the three-dimensional model is abnormal is at least one of a state in which at least one eye of the three-dimensional model is not included in the three-dimensional model image or a state in which at least one eye of the three-dimensional model is similar to a white of eye.
(14)

The information processing method according to any one of (1) to (13),
in which the information processing apparatus analyzes an acquired learning data set, and
replenishes a shortage of at least one of an amount or a quality of the learning data set on the basis of an analysis result of the learning data set.
(15)

The information processing method according to (14),
in which the information processing apparatus detects a bias of the learning data set,
generates the learning data for correcting the bias of the learning data set, and adds the learning data to the learning data set.
(16)

The information processing method according to any one of (1) to (15),
in which the information processing apparatus generates the three-dimensional model and changes a characteristic of the three-dimensional model.
(17)

The information processing method according to any one of (1) to (16),
in which the information processing apparatus further controls a state of the virtual space.
(18)

The information processing method according to any one of (1) to (17),
in which the state of the three-dimensional model includes at least one of an expression or a gesture of the three-dimensional model.
(19)

An information processing apparatus including
an estimation unit that executes estimation processing regarding a person by using a learning model generated by learning using a learning data set that is a set of learning data generated on the basis of a state of a three-dimensional model of the person in a three-dimensional virtual space and a rendering condition for rendering the three-dimensional model while changing the state of the three-dimensional model and the rendering condition, the learning data including input data including a three-dimensional model image that is an image obtained by rendering the three-dimensional model and correct data regarding the three-dimensional model.
(20)

An information processing method including,
by an information processing apparatus, executing estimation processing regarding a person by using a learning model generated by learning using a learning data set that is a set of learning data generated on the basis of a state of a three-dimensional model of the person in a three-dimensional virtual space and a rendering condition for rendering the three-dimensional model while changing the state of the three-dimensional model and the rendering condition, the learning data including input data including a three-dimensional model image that is an image obtained by rendering the three-dimensional model and correct data regarding the three-dimensional model.
(21)

An information processing method including, by an information processing apparatus, executing learning of a learning model that executes estimation processing regarding a person using a learning data set that is a set of learning data generated on the basis of a state of a three-dimensional model of the person in a three-dimensional virtual space and a rendering condition for rendering the three-dimensional model while changing the state of the three-dimensional model and the rendering condition, the learning data including input data including a three-dimensional model image that is an image obtained by rendering the three-dimensional model and correct data regarding the three-dimensional model.

Note that the effects described in the present specification are merely examples and are not limited, and other effects may be achieved.

### REFERENCE SIGNS LIST

101 Information processing system
111 Learning data set generation unit
112 Learning data set accumulation unit
113 Learning unit
114 Estimation unit
151 Object generation unit
152 State control unit
153 Learning data generation unit
301 Information processing system
311 Learning data set generation unit
351 State determination unit
401 Information processing system
411 Learning data set acquisition unit
412 Learning data set replenishment unit
451 Data analysis unit
452 Replenishment planning unit
453 Learning data set generation unit
461 Object generation unit
462 State control unit

What is claimed is:

1. An information processing method comprising, by an information processing apparatus:
controlling a state of a three-dimensional model of a person in a three-dimensional virtual space and a rendering condition for rendering the three-dimensional model; and
generating, on the basis of the state of the three-dimensional model and the rendering condition, input data including a three-dimensional model image that is an image obtained by rendering the three-dimensional model, and learning data including correct data regarding the three-dimensional model.

2. The information processing method according to claim 1,
wherein the state of the three-dimensional model includes at least one of a position or a posture of the three-dimensional model in the virtual space.

3. The information processing method according to claim 2,
wherein the state of the three-dimensional model further includes a direction of an eyeball of the three-dimensional model in the virtual space.

4. The information processing method according to claim 3,
wherein the correct data includes line-of-sight information indicating a line-of-sight direction of the three-dimensional model.

5. The information processing method according to claim 4, wherein
the three-dimensional model image includes both eyes of the three-dimensional model, and
the line-of-sight information indicates one line-of-sight direction with respect to both the eyes of the three-dimensional model.

6. The information processing method according to claim 3,
wherein the information processing apparatus further controls a position of a gaze point indicating a position at which the three-dimensional model gazes in the virtual space, and
controls a direction of an eyeball of the three-dimensional model on a basis of a relative position between the eyeball of the three-dimensional model and the gaze point.

7. The information processing method according to claim 2,
wherein the information processing apparatus controls a relative position and posture between the three-dimensional model and a camera object used for controlling the rendering condition.

8. The information processing method according to claim 2, wherein a posture of the three-dimensional model includes a direction of a face of the three-dimensional model in the virtual space.

9. The information processing method according to claim 1, wherein the information processing apparatus controls the state of the three-dimensional model and the rendering condition, and widens a variation of at least one of the state of the three-dimensional model in the three-dimensional model image or the correct data in a learning data set that is a set of the learning data.

10. The information processing method according to claim 9,
wherein the learning data set is used for learning of a learning model for estimating at least one of a state or a characteristic of a person.

11. The information processing method according to claim 1,
wherein the information processing apparatus determines the state of the three-dimensional model, and
in a case where the information processing apparatus determines that the state of the three-dimensional model is abnormal, the information processing apparatus does not add the learning data based on the three-dimensional model determined to be abnormal to a learning data set that is a set of the learning data.

12. The information processing method according to claim 11,
wherein the state in which the three-dimensional model is abnormal is a state in which learning efficiency may decrease in a case where the learning data including the three-dimensional model image based on the three-dimensional model is used for learning.

13. The information processing method according to claim 12
wherein the state in which the three-dimensional model is abnormal is at least one of a state in which at least one eye of the three-dimensional model is not included in the three-dimensional model image or a state in which at least one eye of the three-dimensional model is similar to a white of eye.

14. The information processing method according to claim 1,
wherein the information processing apparatus analyzes an acquired learning data set, and
replenishes a shortage of at least one of an amount or a quality of the learning data set on a basis of an analysis result of the learning data set.

15. The information processing method according to claim 14,
wherein the information processing apparatus detects a bias of the learning data set,
generates the learning data for correcting the bias of the learning data set, and adds the learning data to the learning data set.

16. The information processing method according to claim 1,
wherein the information processing apparatus generates the three-dimensional model and changes a characteristic of the three-dimensional model.

17. The information processing method according to claim 1,
wherein the information processing apparatus further controls a state of the virtual space.

18. The information processing method according to claim 1,
wherein the state of the three-dimensional model includes at least one of an expression or a gesture of the three-dimensional model.

19. An information processing apparatus comprising
an estimation unit that executes estimation processing regarding a person by using a learning model generated by learning using a learning data set that is a set of learning data generated on a basis of a state of a three-dimensional model of the person in a three-dimensional virtual space and a rendering condition for rendering the three-dimensional model while changing the state of the three-dimensional model and the rendering condition, the learning data including input data including a three-dimensional model image that is an image obtained by rendering the three-dimensional model and correct data regarding the three-dimensional model.

20. An information processing method comprising,
by an information processing apparatus, executing estimation processing regarding a person by using a learning model generated by learning using a learning data set that is a set of learning data generated on a basis of a state of a three-dimensional model of the person in a three-dimensional virtual space and a rendering condition for rendering the three-dimensional model while changing the state of the three-dimensional model and the rendering condition, the learning data including input data including a three-dimensional model image that is an image obtained by rendering the three-dimensional model and correct data regarding the three-dimensional model.
